(19) United States
(12) Patent Application Publication
(10) Pub. No.: US 2005/0098584 A1
(43) Pub. Date: May 12, 2005

(54) Dispensing device with pivoting spray nozzle

(76) Inventor: Paulo Do Rosario, Louviers Les Monts (FR)

Correspondence Address: YOUNG & THOMPSON, 745 SOUTH 23RD STREET, 2ND FLOOR, ARLINGTON, VA, 22202, US

(21) Appl. No.: 10/937,407

(22) Filed: Sep. 10, 2004

(30) Foreign Application Priority Data
Mar. 6, 2002 (FR) 02 02816

(51) Int. Cl. B67D 5/64

(52) U.S. Cl. 222/321.7; 222/321.9

(57) ABSTRACT

Pump device for dispensing a liquid or pasty product packaged in a container (1), said device comprising a pump (3) equipped with a hollow piston stem (5), a rigid actuating lever (50) mounted so as to pivot with respect to said container to actuate said pump, a dispensing nozzle (26) fastened to said actuating lever so as to pivot with the latter, an endpiece (24) coupled to said outer end of the hollow stem, and a connecting duct (25) linking said endpiece to said dispensing nozzle, characterized in that said actuating lever (50) is able to cooperate by sliding contact with said endpiece to cause said hollow stem to slide in said actuating direction when said actuating lever pivots, said connecting duct (25) being able to deform elastically when the hollow stem thus slides.

The present invention relates to pump devices for dispensing a liquid or pasty product packaged in a container, especially a perfume, a cosmetic product or a pharmaceutical product.

More precisely, the invention relates to such a device of the type comprising a pump equipped with a pump body fastened to a wall of said container and with a hollow piston stem that can slide axially in said pump body in an actuating direction in opposition to an elastic return member to expel an amount of said product through an outer end of said hollow stem, a rigid actuating lever mounted so as to pivot with respect to said container to actuate said pump, a dispensing nozzle fastened to said actuating lever so as to pivot with the latter, an endpiece coupled to said outer end of the hollow stem, and a connecting duct linking said endpiece to said dispensing nozzle so as to bring the product that is expelled when said pump is actuated to said dispensing nozzle so as to dispense said product through said dispensing nozzle.

In this type of device, there is a variation in distance and orientation between the nozzle and the end of the hollow stem when the pump is actuated, which may give rise to stresses in the pump stem that can cause the device to age more quickly. Such stresses must therefore be avoided.

Document FR 2 735 188 A1 discloses a device of this type in which the connecting duct and the endpiece are formed as a single piece with the rigid actuating lever of the device. Such a design is aimed at reducing the manufacturing cost of the device. The abovementioned variation in distance and orientation is absorbed by elastically deforming the pump stem, which is designed to be flexible. A drawback with this device is that it does not allow the use of standard pumps, in which the pump stem is rigid. On the contrary, a pump with a flexible stem has to be specially made for this device, which increases its cost.

Moreover, in this known device, to be able to cause the hollow pump stem to slide while deforming it, the angle of buckling of the stem must be limited. This is achieved by making a large length of stem project out of the pump body. This known device is therefore of considerable size in the direction of projection of the pump stem, above the container.

Document FR 2 682 937 A3 proposes a device of similar design, in which the rigid pump stem is connected to the endpiece formed as a single piece with the rigid actuating lever by means of an attached flexible tubular element. This device is also of considerable size in the direction of projection of the pump stem.

Document FR 2 715 585 A1 also discloses a device in which the connecting duct and the endpiece are formed as a single piece with the rigid actuating lever of the device. The abovementioned variation in orientation is absorbed by elastically deforming the endpiece. A drawback with this device is that the wall of the endpiece, being made as a single piece with the lever, must be made of a material that is relatively rigid and very thin in order to be flexible, which limits its fatigue strength and thus limits the application of this device, in practice, to very small lever pivoting angles.

The aim of the invention is to propose a pump device that at least partly solves the abovementioned drawbacks. In particular, the invention aims to propose a pump device of small size in the direction of projection of the pump stem.

To this end, the invention provides a device of the above type characterized in that said actuating lever is able to cooperate by sliding contact with said endpiece to cause said endpiece and said hollow stem to slide in said actuating direction when said lever pivots, said connecting duct being able to deform elastically when the hollow stem thus slides.

This design of the endpiece and actuating lever as two elements that can cooperate by sliding contact makes it possible to dissociate their respective movements in the directions transverse to the hollow stem, so that the pivoting movement of the lever causes an axial sliding movement of the endpiece and hollow stem, the fact that the endpiece and actuating lever cooperate slidingly eliminating any transmission of the pivoting torque of the lever to the endpiece and to the hollow stem. The transmission to the endpiece and to the hollow stem of forces in the directions transverse to the hollow stem is also greatly reduced. The variation in distance and relative orientation between the nozzle and the hollow stem is absorbed, completely or largely, by the elastic deformation of the connecting duct.

According to a particular feature of the invention, the device comprises a guide means fastened to said container to guide said endpiece in translation along the axis of the hollow stem. Advantageously, said guide means comprises at least one guide rib fastened to said container around said pump body and projecting substantially parallel to said hollow stem. The guide means takes up all the residual transverse stresses that may be transmitted by the lever to the endpiece which are not, therefore, transmitted to the hollow stem.

Preferably, said connecting duct runs transversely to said hollow stem, said connecting duct deforming by bending when said hollow stem slides.

Advantageously, said connecting duct comprises a preferential bending zone formed by a localized thinning of its wall.

The materials must be chosen so as to be compatible with the product to be dispensed and so as to avoid materials that would age more quickly as a result of contact with the contents of the container. As is known, the actuating lever may be made rigid by choosing a rigid material and/or a considerable thickness of material. By contrast, the relative flexibility of the connecting duct is achieved by choosing a more flexible material and/or a smaller thickness of material. For example, the actuating lever, the endpiece and the connecting duct may be made of the same plastic, such as polypropylene, by using a greater thickness of material and a higher grade polypropylene for the actuating lever than for the endpiece and particularly than for the connecting duct. For example, the lever may thus be made of acrylonitrile-butadiene-styrene (ABS), high-density polyethylene or any other rigid material.

Preferably, the endpiece and the connecting duct are molded as a single piece from a more flexible material than the actuating lever. This material is chosen so as to meet multiple conditions: ensure good sealing of the coupling between the endpiece and the hollow stem, ensure efficient transmission of force between the actuating lever and the hollow stem, and ensure satisfactory flexibility of the connecting duct. For example, polypropylene has proved to be a satisfactory choice.

Advantageously, the actuating lever comprises a top pressing wall mounted at a distance from said container substantially at right angles to said hollow stem, so as to house said hollow stem and said endpiece between it and said container wall bearing the pump body, said actuating lever cooperating with said endpiece by sliding contact between an inside surface of said top wall and a top surface of said endpiece. Thus, the pump is actuated by manually pressing on the top wall of the actuating lever, this wall transmitting this pressure to the endpiece by sliding contact.

Preferably, said top surface of the endpiece has a face that is substantially at right angles to said hollow stem and able to receive the pressure from said top wall of the actuating lever at the start of pivoting travel of said actuating lever, and an inclined face able to receive the pressure from said top wall of the actuating lever at the end of pivoting travel of said actuating lever.

Advantageously, the actuating lever comprises a peripheral skirt extending from the peripheral edge of said top wall toward said container wall, said skirt comprising a bore for receiving said dispensing nozzle with functional clearance.

Advantageously, an outer covering side wall is fastened to said container so that it extends between said container wall and said top wall of the actuating lever, substantially surrounding said actuating lever, said side wall comprising an opening for the passage of the product expelled through said dispensing nozzle when said actuating lever pivots.

Preferably, the covering side wall bears two pin portions projecting from its inside surface that can engage in two corresponding pin holes in the actuating lever to provide the pivot axis for said actuating lever.

Advantageously, the pin holes have the shape of a slot with a substantially semicircular end wall to allow said pin portions to engage laterally in said pin holes. This feature facilitates the mounting of the actuating lever.

Preferably, at least one guide tab is fastened to said container, capable of engaging in a guide slit made in said actuating lever in the form of a circular. arc centered on one of said pin holes to keep said actuating lever pivotally mounted on said pin portions.

Advantageously, said pin holes are located near said dispensing nozzle.

According to another particular feature of the invention, the device comprises an elastic member fastened to said container and able to be deformed by said actuating lever during its pivoting travel so as to return said actuating lever to a rest position corresponding to the rest position of said hollow stem.

Advantageously, said endpiece comprises at least one stub that is transverse to the axis of the hollow stem and able to be engaged through an opening in said actuating lever to receive the thrust of said actuating lever in said actuating direction.

Advantageously, in total, said actuating lever pivots by between 5 and 20 degrees, preferably between 8 and 12 degrees.

The invention will be more easily understood, and other aims, details, features and advantages thereof will emerge more clearly from the following description of a particular embodiment of the invention, given solely by way of nonlimiting illustration, with reference to the attached drawing. In this drawing:

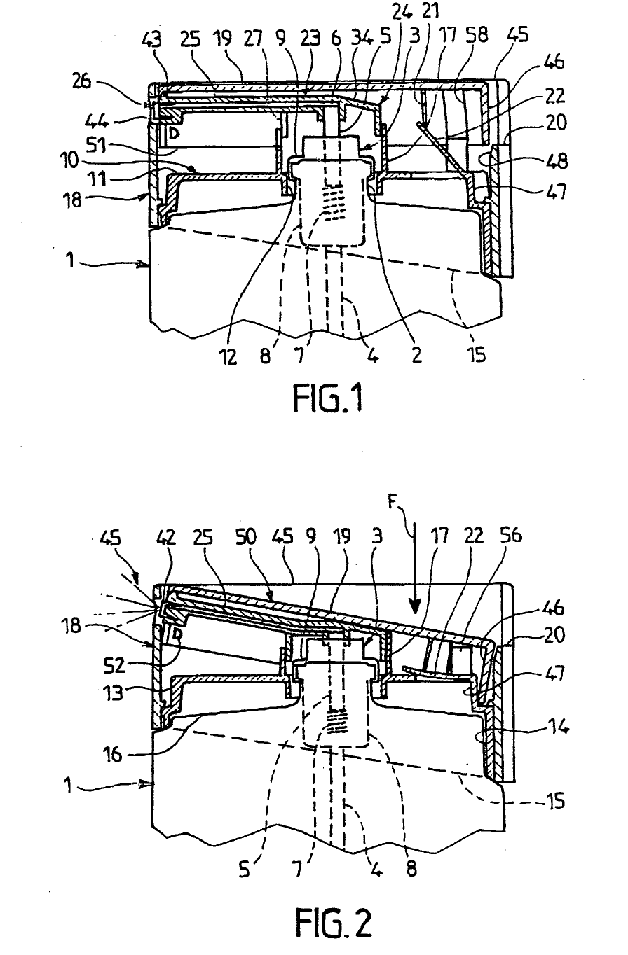

FIG. 1 is a sectional view of a bottle equipped with a device according to the invention, with the pump stem in the rest position,

FIG. 2 is a view similar to FIG. 1, the pump stem having slid in the actuating direction,

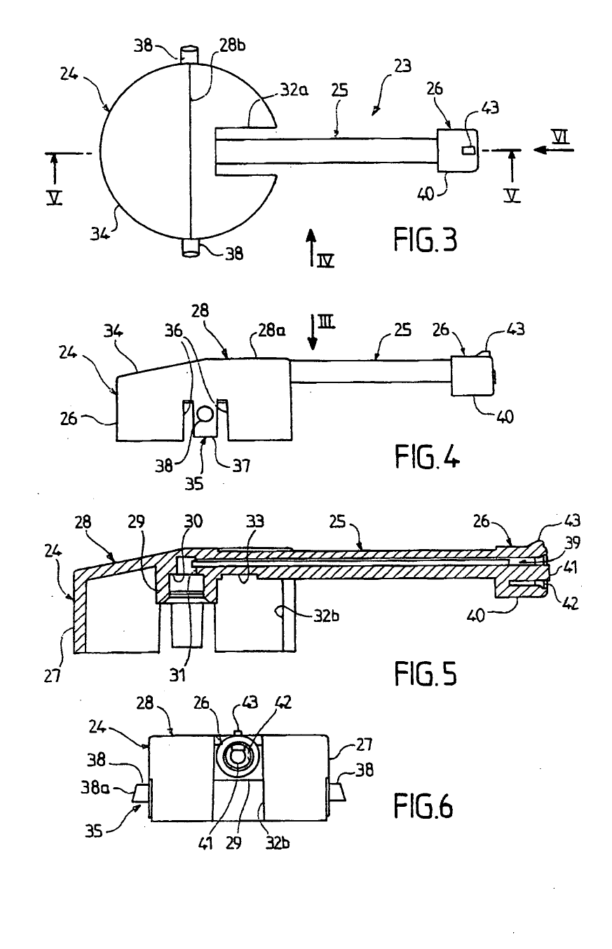

FIG. 3 is a top view of a push-button assembly of the device of FIG. 1,

FIG. 4 is a side view of the push-button assembly of FIG. 3 along the arrow IV,

FIG. 5 is a view of the push-button assembly of FIG. 3 in section along the line V-V,

FIG. 6 is a flat view of the push-button assembly of FIG. 3 along the arrow VI,

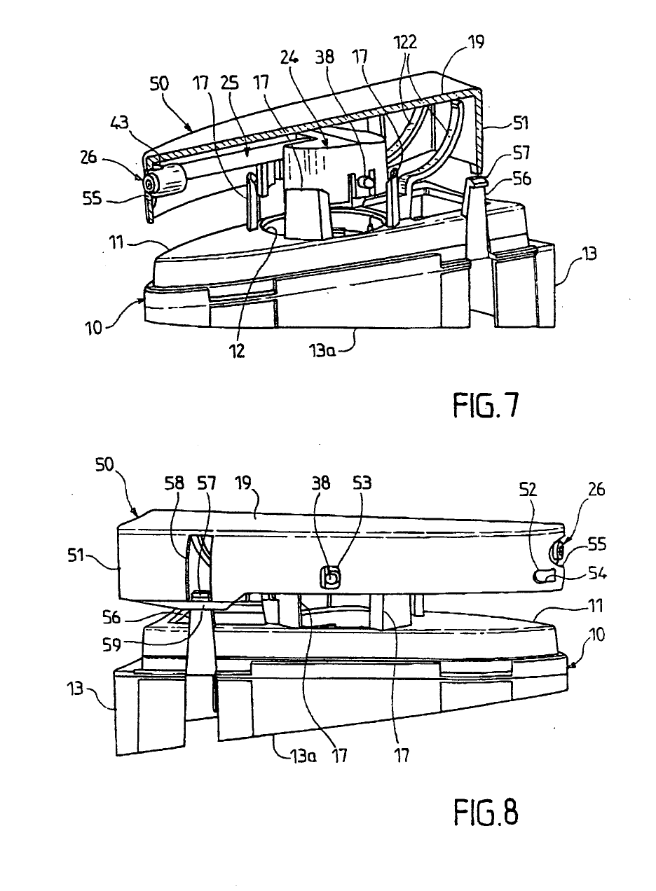

FIG. 7 is a perspective view in half-section showing the actuating lever, the push-button assembly and the cover base of the device of FIG. 1 in the rest position,

FIG. 8 is a perspective view showing the same elements as FIG. 7 from another angle,

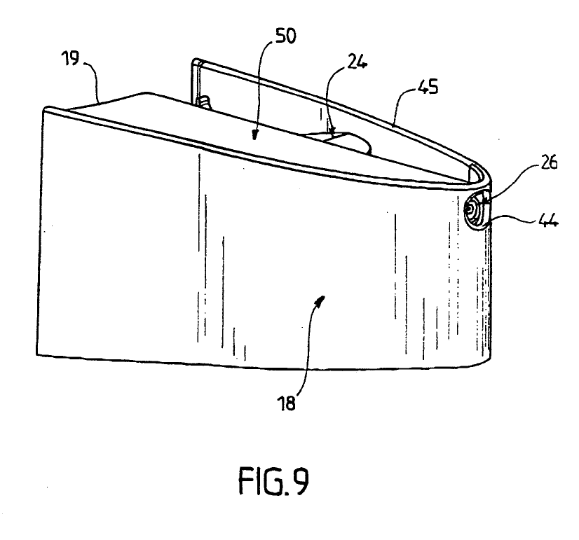

FIG. 9 is a view similar to FIG. 8 showing the device covered with a covering side wall.

FIGS. 1 and 2 show a bottle 1, for example a perfume bottle, comprising a neck 2 in which a pump 3 is mounted. For example, the bottle 1 is cylindrical with a circular, rectangular or some other cross section. In the example shown in FIGS. 7 to 9, the bottle has a cross section in the shape of an ogive with a triangular arch or is shaped like the baseplate of an iron. The pump 3 is a pump of known type comprising a pump body 8, a hollow piston stem 5 that can move axially in the pump body 8 to actuate the pump and expel product through the free end 6 of the hollow stem 5, and a conveying tube 4 connected to the pump body 3 and immersed in the product contained in the bottle so as to suck the product up when the pump is actuated. A return spring 7 is mounted in the pump body 8 to return the hollow stem 5 to its rest position in which the hollow stem 5 projects outside the pump body 8, as can be seen in FIG. 1. The pump body 8 is fastened to the neck 2 by crimping using a metal ring 9.

The dispensing device mounted on the bottle 1 is also shown without the bottle or pump in FIGS. 7 to 9. It comprises a cover base 10 fastened to the top of the bottle 1, for example by snap-fastening. The cover base 10 comprises a base wall 11 extending transversely to the neck 2 and passed through by the latter at a central opening 12. At the periphery of the base wall 11, the cover base 10 also comprises a side wall 13 extending at right angles to the base wall 11 and bearing, via its lower edge 13a, visible in FIG. 7, on the bottle 1. At the periphery of the upper wall 16 of the bottle 1, which bears the neck 2, the wall of the bottle 1 has a lateral recess 14 that forms a peripheral ledge 15 on which the edge 13a bears. The peripheral ledge 15 is inclined such that it slopes linearly away from the upper wall 16 from the front to the rear of the bottle 1. Likewise, the height of the side wall 13 of the cover base 10 increases rearward.

Around the central opening 12, the base wall 11 bears a plurality of guide ribs 17 projecting parallel to the axis of the neck 2 and of the hollow stem 5, whose guide surface facing the opening 12 forms part of the same cylindrical surface of circular section. Four guide ribs 17 are shown in FIGS. 7 and 8.

The dispensing device mounted on the bottle 1 also comprises a covering side wall 18, also visible in FIG. 9, fastened on the cover base 10 by snap-fastening and surrounding the cover base 10 and the pump 3 substantially in alignment with the side wall of the bottle 1, so as to extend the bottle 1 beyond the neck 2 to protect and cover up the dispensing device.

A pivoting actuating lever 50, comprising a top wall 19 and a peripheral skirt 51 extending, at right angles, toward the bottle 1, is fastened to the covering side wall 18 so as to be able to pivot. The pivot axis of the actuating lever 50 is located at the front of the bottle 1 and is provided in the form of two aligned horizontal pin portions borne by the covering side wall 18 on its inside surface and projecting toward the peripheral skirt 51. These two pin portions, which are not shown, engage in two corresponding pin holes 52 made in the peripheral skirt 51, only one of which is visible in FIG. 8. The peripheral skirt 51 thus extends parallel to the covering side wall 18, inside the latter. As can be seen in FIG. 8, each pin hole 52 has the shape of a slot that is open toward the front of the lever 50 and has a semicircular end wall toward the rear of the lever 50. At the time of assembly, the lever 50 is inserted in the side wall 18 from the rear end of the latter, such that the pin portions enter the slots 52 laterally to said slots until they are housed in the end wall of the slots 52. A narrowing 54 in the middle of the slots 52 makes it possible to snap-fit the pin portions securely.

With reference to FIGS. 1 and 2, the covering side wall 18 has, at its rear part, a central cutout 20 allowing one or more fingers, for example the user's thumb, to be inserted to press on the top wall 19. The inside surface of the top wall 19 bears a rib 21 projecting toward an elastic strip 22 borne by the base wall 11 so as to cooperate with it. The elastic strip 22 is molded as a single piece with the base wall 11.

The dispensing device mounted on the bottle 1 also comprises a push-button assembly 23 composed of an endpiece 24 to be coupled to the end 6 of the hollow stem 5, a dispensing nozzle 26 to be fastened to the front end of the pivoting lever 50, just above the pin holes 52, so as to pivot with said lever, and a connecting duct 25 linking the endpiece 24 to the dispensing nozzle 26. The push-button assembly 23 will now be described in more detail with reference to FIGS. 3 to 6.

The endpiece 24 has a generally cylindrical outer shape of circular section. The section of its side wall 27 is adapted to slide between the guide ribs 17, being guided in translation by said ribs coaxially to the hollow stem 5.

On one side the side wall 27 is closed by a disk-shaped top wall 28 and on the other it is open to fit over the top of the pump body 8 and receive the hollow stem 5. The free end 6 of the hollow stem 5 fits into a coupling sleeve 29 borne by the wall 28 substantially at the center of its inside surface. The coupling sleeve 29 is designed to enclose in a leaktight manner the end 6 of the hollow stem 5, which bears axially against a shoulder 30 inside the sleeve 29 in the assembled position. Opposite the end opening of the hollow stem 5 in the assembled position, the sleeve 29 defines an upper chamber 31 opening out laterally into a first end of the connecting duct 25.

The connecting duct 25 runs at right angles to the axis of the endpiece 24. On the connecting duct 25 side, the top wall 28 and side wall 27 have rectangular cutouts 32a and 32b to allow the duct 25 to pass through and deform by bending. Near its end connected to the sleeve 29, the connecting duct 25 has a zone 33 in which the wall of the duct is made locally thinner to promote the bending of the duct 25 at this point. The half of the top wall 28 that is away from the connecting duct 25 forms a downward-sloping face 34, making an angle of around 10.5° with the other half 28a of the top wall 28, which is a face at right angles to the side wall 27. The two faces 28a and 34 of the top wall 28 meet along an edge 28b that is transverse with respect to the connecting duct 25.

Along a diameter at right angles to the connecting duct 25, the side wall 27 has two diametrically opposed bearing parts 35. Each bearing part 35 comprises a rectangular tab 37 delimited by two narrow rectangular notches 36 running at right angles to the lower edge of the wall 27. Each tab 37 bears a cylindrical stub 38 projecting at right angles to the side wall 27. The end face 38a of the stubs 38 is beveled. In the assembled position of the endpiece 24, the stubs 38 engage in corresponding openings 53 in the peripheral skirt 51, as can be seen in FIG. 8. The stubs 38 serve to increase the transmission of force from the actuating lever 50 to the endpiece 24 in the axial direction of the stem 5 when the lever 50 pivots. When said lever pivots, the upper edge of each opening 53 bears downward on the corresponding stub 38. The openings 53 are wider than the diameter of the stubs 38 to allow the peripheral skirt 51 to slide a little laterally about the stubs 38 when the lever 50 pivots, so that the latter is not impeded in its pivoting movement.

The connecting duct 25 bears the dispensing nozzle 26 at its second end, away from the endpiece 24. The dispensing nozzle 26 comprises an annular chamber 39 defined by a cylindrical wall 40, whose section is greater than that of the duct 25, and a central stub 41. A spraying member 42 is mounted on the outlet face of the chamber 39 around the stub 41 to define an outlet of restricted cross section designed to break up the jet of expelled product into fine droplets. The connecting duct 25 opens out into an upper part of the annular chamber 39.

With reference to FIG. 7, the dispensing nozzle 26 is mounted in the actuating lever 50 in the following manner. The nozzle 26 is engaged via its front end in a bore 55 made at the front of the peripheral skirt 51. On its upper side, the cylindrical wall 40 of the nozzle bears a fin 43 designed to cooperate with the peripheral skirt 51 above the bore 55, to prevent the nozzle 26 from passing completely through said bore.

The nozzle 26 does not fit tightly in the bore 55. On the contrary, it has a degree of functional clearance allowing the nozzle 26 to move backward when the lever 50 pivots. The nozzle 26 is kept engaged in the bore 55 for the whole operating cycle of the device by the connecting duct 25, which is sufficiently rigid to ensure this holding function.

With reference to FIG. 8, on a rear part, the cover base 10 has two guide tabs 56 that extend at right angles to the wall 11 from two opposite lateral sides of the base wall 11. Each guide tab 56 ends in a hook 57 projecting laterally outward from the cover base 10. The tabs 56 serve to hold the lever 50 in alignment with the cover base 10 and prevent it from being able to come off its pivoting pin. To this end, when the actuating lever 50 is mounted on its pivoting pin, the hooks 57 are engaged in two symmetrical slits 58 made in the skirt 51. This is achieved by elastically bending the tabs 56 slightly. Each slit 58 is in the shape of an annular strip centered on the pin hole 52 borne on the same face of the peripheral skirt 51 and runs substantially from the top wall 19 to the base of the skirt 51. However, the slits 58 are closed at their base by respective lower ledges 59 of the skirt 51.

The way in which the dispensing device works will now be explained with reference to FIGS. 1 and 2.

In the rest position shown in FIG. 1, the hollow stem 5 is held in a position protruding from the pump body 8 under the action of the spring 7. The endpiece 24 is coupled to the stem 5 and the lower part of its side wall 27 is engaged in the ribs 17. The elastic tab 22 is deployed, straight, and holds the top wall 19 of the lever 50 at right angles to the covering side wall 18, in alignment with the upper edge 45 of the covering side wall 18, as shown in FIGS. 1 and 2, or slightly below the upper edge 45, as shown in FIG. 9. The hooks 57 are in abutment against the lower ledges 59. A small space separates the endpiece 24 from the top wall 19 of the lever 50. The duct 25 runs straight, at right angles to the axis of the hollow stem 5 toward the front of the device. The dispensing nozzle 26 is oriented in alignment with the duct 25 and engaged in the bore 55, the fin 43 being in abutment against the inside surface of the skirt 51. The covering side wall 18 has an outlet opening 44 in alignment with the duct 25 and the bore 55, opposite the dispensing nozzle 26. The pivoting pin of the lever 50 is transverse to the axial direction of the stem 5.

To actuate the dispensing device, a user exerts a force directed toward the bottle 1, along the arrow F in FIG. 2, on the rear part of the top wall 19. Typically, such a force is exerted with the user's thumb or index finger which engages in the cutout 20 as the wall 19 pivots. In the course of its pivoting movement, the underside of the top wall 19 bears on the top wall 28 of the endpiece 24 and the upper edges of the openings 53 also bear on the stubs 38, ensuring force is transmitted, thus causing the endpiece 24 and the hollow stem 5 to slide along the axis of the hollow stem 5. Thus, a metered quantity of product is ejected through the hollow stem 5, the chamber 31 of the endpiece 24, the duct 25, the nozzle 26 and the opening 44, and forms a jet 45 of product sprayed in front of the latter.

As the device is actuated, the endpiece 24 is guided in translation parallel to the hollow stem 5 by the ribs 17 cooperating with the side wall 27, such that the hollow stem 5 slides axially into the pump body 8 without undergoing transverse stress. The top wall 28 of the endpiece receives the pressure from the top wall 19 of the lever 50, first on the face 28a, then on the edge 28b, and then on the inclined face 34. The top wall 28 of the endpiece slides relative to the top wall 19 of the lever 50 as the device is actuated. Specifically, as the endpiece moves in actuation, the top wall 28 moves a little closer to the pivot axis of the lever 50 defined by the pin holes 52, while the various parts of the lever 50 remain by definition at a constant distance from this axis.

When the lever 50 is pivoted downward, the hook parts 57 of the guide tabs 56 slide upward in the respective slits 58 and help guide the lever 50 to pivot about the axis defined by the pin holes 52.

As the endpiece 24 slides downward, the second end part of the duct 25, which is fastened to the nozzle 26, itself fastened to the skirt 51 of the lever 50, undergoes a pivoting movement that changes its orientation with respect to the first end part of the duct 25, which is connected to the endpiece 24 and whose orientation does not change. The connecting duct 25 thereby deforms elastically by bending between its two end parts. The deformation of the duct 25 is essentially concentrated in the preferential bending zone 33, where a bend forms.

Owing to the pivoting movement of the lever 50 about the axis defined by the pin holes 52 and to the related downward sliding movement of the endpiece 24, the distance between the endpiece 24 and the bore 55 in which the nozzle 26 is mounted increases slightly. This increase in distance does not result in an extension of the connecting duct 25 but in a slight retraction of the nozzle 26, which is not held tightly in the bore 55. However, the device is designed such that this retraction is slight enough with respect to the length of the nozzle portion 26 that is engaged through the bore 55 to avoid any risk of the nozzle coming out of the bore 55. For example, in total the nozzle 26 retracts about a few tenths of a millimeter as the device is actuated.

The dispensing nozzle 26, which is integral with the front end of the lever 50, pivots with the latter as the product is ejected. The opening 44 is designed to allow the jet 45 to pass through throughout the whole pivoting movement described by the nozzle 26. The actuation travel of the hollow stem 5 corresponds to a pivoting of the lever 50 by an angle of around 10.5° in the example shown.

At the end of pivoting travel, the wall 19 is in abutment against the inclined face 34 of the endpiece 24. The elastic strip 22 is pushed down against the base wall 11 by the rib 21. The rear part 46 of the skirt 51 enters a space between the rear part of the covering side wall 18, beneath the cutout 20, and a recessed face 47 of the side wall 13 of the cover base 10. At the bottom of the cutout 20, the covering side wall 18 has a beveled edge 48 to ensure the rear part 46 of the skirt 51 can pass freely.

When the pivoting lever 50 is released, the elastic strip 22 and the spring 7 return the various elements to their rest positions, in a direction opposite to the actuation direction, the duct 25 elastically resuming its straight shape.

FIG. 7 shows two elastic tabs 122 whose shape differs from the tab 22 of FIGS. 1 and 2 but that fulfill the same function as said tab. Each tab 122 is also molded as a single piece with the cover base 10 and has a free end bearing directly on the inside surface of the top wall 19 of the lever 50, such that it is possible to dispense with the rib 21 when the tabs 122 are used.

Note that the device thus constructed is of small size in the axial direction of the hollow piston stem 5. This size is mainly defined by the length of travel of the hollow stem 5, which may be varied by a corresponding design of the pump 3, in a way known to those skilled in the art.

For a given length of travel, the maximum pivoting angle of the lever 50 may be varied by adapting the distance between the axis of rotation of the lever 50 and the hollow stem 5 in a plane transverse to the axial direction of the stem 5. The pivoting angle necessary to actuate the pump decreases as this distance is increased, and vice versa. The more the wall 19 remains substantially transverse to the axial direction of the stem 5, the less the force transmitted from the lever 50 to the endpiece 24 transversely to the axial direction of the stem 5; this can be achieved by increasing the distance between the axis of rotation of the lever 50 and the hollow stem 5 in a plane transverse to the axial direction of the stem 5. For example, this transmission of force is kept within acceptable limits by selecting a pivoting angle of less than 20 degrees, preferably less than 12 degrees.

Although the invention has been described in conjunction with a particular embodiment, it is of course not limited to it in any way and comprises all technical equivalents of the means described together with combinations thereof if these fall within the scope of the invention.

1. Pump device for dispensing a liquid or pasty product packaged in a container (1), said device comprising a pump (3) equipped with a pump body (8) fastened to a wall (16) of said container and with a hollow piston stem (5) that can slide axially in said pump body in an actuating direction (F) in opposition to an elastic return member (7) to expel an amount of said product through an outer end (6) of said hollow stem, a rigid actuating lever (50) mounted so as to pivot with respect to said container to actuate said pump, a dispensing nozzle (26) fastened to said actuating lever so as to pivot with the latter, an endpiece (24) coupled to said outer end of the hollow stem, and a connecting duct (25) running transversely to said hollow stem and linking said endpiece to said dispensing nozzle so as to bring the product that is expelled when said pump is actuated to said dispensing nozzle, characterized in that said actuating lever (5) is able to cooperate by sliding contact with said endpiece to cause said endpiece and said hollow stem to slide in said actuating direction when said actuating lever pivots, said connecting duct (25) being able to deform elastically by bending when the hollow stem thus slides.

2. Device according to claim 1, characterized in that it comprises a guide means (17) fastened to said container to guide said endpiece in translation along the axis of the hollow stem.

3. Device according to claim 2, characterized in that said guide means comprises at least one guide rib (17) fastened to said container around said pump body (8) and projecting substantially parallel to said hollow stem(5).

4. Device according to claim 1, characterized in that said connecting duct comprises a preferential bending zone (33) formed by a localized thinning of its wall.

5. Device according claim 1, characterized in that said endpiece (24) and said connecting duct (25) are molded as a single piece from a more flexible material than the actuating lever.

6. Device according to claim 1, characterized in that said actuating lever (50) comprises a top pressing wall (19) mounted at a distance from said container substantially at right angles to said hollow stem, so as to house said hollow stem and said endpiece between it and said container wall (16) bearing the pump body, said actuating lever cooperating with said endpiece by sliding contact between an inside surface of said top wall and a top surface (28) of said endpiece.

7. Device according to claim 6, characterized in that said top surface (28) of the endpiece has a face (28a) that is substantially at right angles to said hollow stem and able to receive the pressure from said top wall (19) of the actuating lever at the start of pivoting travel of said actuating lever, and an inclined face (34) able to receive the pressure from said top wall (19) of the actuating lever at the end of pivoting travel of said actuating lever.

8. Device according to claim 6, characterized in that said actuating lever comprises a peripheral skirt (51) extending from the peripheral edge of said top wall (19) toward said container wall, said skirt comprising a bore (55) for receiving said dispensing nozzle (26) with functional clearance.

9. Device according to claim 6, characterized in that it comprises an outer covering side wall (18) fastened to said container so that it extends between said container wall (16) and said top wall (19) of the actuating lever, substantially surrounding said actuating lever, said side wall (18) comprising an opening (44) for the passage of the product (45) expelled through said dispensing nozzle (26) when said actuating lever pivots.

10. Device according to claim 9, characterized in that said covering side wall bears two pin portions projecting from its inside surface than can engage in two corresponding pin holes (52) in the actuating lever (50) to provide the pivot axis for said actuating lever.

11. Device according to claim 10, characterized in that said pin holes (52) have the shape of a slot with a substantially semicircular end wall to allow said pin portions to engage laterally in said pin holes.

12. Device according to claim 11, characterized in that it comprises at least one guide tab (56) fastened to said container, capable of engaging in a guide slit (58) made in said actuating lever in the form of a circular arc centered on one of said pin holes (52) to keep said actuating lever pivotally mounted on said pin portions.

13. Device according to claim 10, characterized in that said pin holes (52) are located near said dispensing nozzle (26).

14. Device according to claim 1, characterized in that it comprises an elastic member (22, 122) fastened to said container and able to be deformed by said actuating lever (50) during its pivoting travel so as to return said actuating lever to a rest position corresponding to the rest position of said hollow stem.

15. Device according to claim 1, characterized in that said endpiece (24) comprises at least one stub (38) that is transverse to the axis of the hollow stem and able to be engaged through an opening (53) in said actuating lever to receive the thrust of said actuating lever in said actuating direction (F).

16. Device according to claim 1, characterized in that in total, said actuating lever pivots by between 5 and 20 degrees, preferably between 8 and 12 degrees.

17. Device according to claim 7, characterized in that said actuating lever comprises a peripheral skirt (51) extending from the peripheral edge of said top wall (19) toward said container wall, said skirt comprising a bore (55) for receiving said dispensing nozzle (26) with functional clearance.

18. Device according to claim 7, characterized in that it comprises an outer covering side wall (18) fastened to said container so that it extends between said container wall (16) and said top wall (19) of the actuating lever, substantially surrounding said actuating lever, said side wall (18) comprising an opening (44) for the passage of the product (45) expelled through said dispensing nozzle (26) when said actuating lever pivots.

19. Device according to claim 8, characterized in that it comprises an outer covering side wall (18) fastened to said container so that it extends between said container wall (16) and said top wall (19) of the actuating lever, substantially surrounding said actuating lever, said side wall (18) comprising an opening (44) for the passage of the product (45) expelled through said dispensing nozzle (26) when said actuating lever pivots.

20. Device according to 17, characterized in that it comprises an outer covering side wall (18) fastened to said container so that it extends between said container wall (16) and said top wall (19) of the actuating lever, substantially surrounding said actuating lever, said side wall (18) comprising an opening (44) for the passage of the product (45) expelled through said dispensing nozzle (26) when said actuating lever pivots.
